(19) United States
(12) Patent Application Publication
(10) Pub. No.: US 2005/0005282 A1
(43) Pub. Date: Jan. 6, 2005

(54) Pick-up head for an optical recording and/or reproducing instrument

(76) Inventor: Chun-Ming Chen, Taipei Hsien (TW)

Correspondence Address: BIRCH STEWART KOLASCH & BIRCH, PO BOX 747, FALLS CHURCH, VA, 22040-0747, US

(21) Appl. No.: 10/880,547

(22) Filed: Jul. 1, 2004

(30) Foreign Application Priority Data
Jul. 2, 2003 (TW) 092118113

(51) Int. Cl. G11B 3/70

(52) U.S. Cl. 720/672

(57) ABSTRACT

A pick-up head for an optical recording and/or reproducing instrument includes a carriage seat and a heat sink disposed on the carriage seat. The heat sink has a plurality of protrusions projecting upwardly from an upper surface therefrom and of specific configuration to divert flow of air toward a corresponding article.

### FIELD OF THE INVENTION

The invention relates to a pick-up head, more particularly to a pick-up head for an optical recording and/or recording instrument provided with a heat sink so as to enhance the heat dissipating effect of the pick-up head.

### BACKGROUND OF THE INVENTION

The advent of personal computer production consequently brings improvements to the peripheral devices. The computer peripheral devices, such as optical recording and/or reproducing instruments, hard drives, image scanners, and printers are widely used not only in offices, but also at homes due to their low costs. The optical recording and/or reproducing instrument, such as a DVD player, is most common and is appreciated by the consumer due to its large storage space and since the data can be stored in an optical disk in image or music modes for a long period of time. A DVD (digital versatile disc) of the latest development has 17 GB storage capacity, possesses high transmission characteristics, and causes wide utility of the DVD player by the consumers.

Referring to FIG. 1, a conventional DVD player is shown to include a transverse module 5, a spindle motor 10, a disk loader 12 mounted on the spindle motor 10, an optical disk (not shown) mounted on the disk loader 12 so as to be rotated by the spindle motor 10, a guiding rail 17 mounted on the transverse module 5, a carriage seat 15 slidably mounted on the rail 17, and a pick-up head 14 mounted on the carriage seat 15. The carriage seat 15 is movable on the rail 17 upon actuation of a sled motor 18, which in turn, causes the pick-up head 14 to move horizontally on the transverse module 5. The pick-up head 14 is provided with a voice coil motor (not shown), which cooperates with the sled motor 18 to enable the pick-up head 14 to move downward and upward along the vertical direction with respect to the transverse module 5 in order to precisely focus the laser beam on a recording surface of the optical disk, thereby permitting reading operation of the data from front, rear, upward and downward positions of the optical disk.

An important aspect to note is that as the reading rate or data recording rate is increased, the rotation speed of the spindle motor 10, the sled motor 18 and the voice coil motor subsequently hasten, thereby generating intensive heat within the DVD player. A cooling fan is generally installed in the conventional DVD player in order to dissipate the intensive heat therefrom.

For an optical recording and/or reproducing instrument, the aforesaid cooling fan can provide a limited heat dissipating effect to the current pick-up head 14 due to presence of the voice coil motor, the integrated circuit chip, the laser diode, and the optical components, which are subjected to generate heat. Once these components are under fast operation during the reading of the optical disk, the pick-up 14 moves swiftly via the voice coil motor so as to enable the integrated circuit to execute a large amount of data transmission, thereby resulting in high temperatures within an outer casing of the pick-up head 14. There may occur incorrect reading operation of the pick-up head 14. Since high efficient laser beams are used in order to record the data on the optical disk, the heat dissipation problem thereof is aggravated.

### SUMMARY OF THE INVENTION

The object of the present invention is to provide a pick-up head for an optical recording and/or recording instrument which is provided with a heat sink so as to enhance the heat dissipating effect of the pick-up head.

According to the present invention, an optical recording and/or reproducing instrument is provided to include: a control chip; and a heat sink disposed above the control chip, and having a plurality of protrusions projecting upwardly therefrom. Preferably, a carriage seat is disposed below the control chip to support the latter. The heat sink is formed with a plurality of mounting holes. A plurality of fasteners extend through the mounting holes in the heat sink for fastening the carriage seat.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view, illustrating relationship of a pick-up head and a transverse module in a conventional optical recording and/or reproducing instrument;

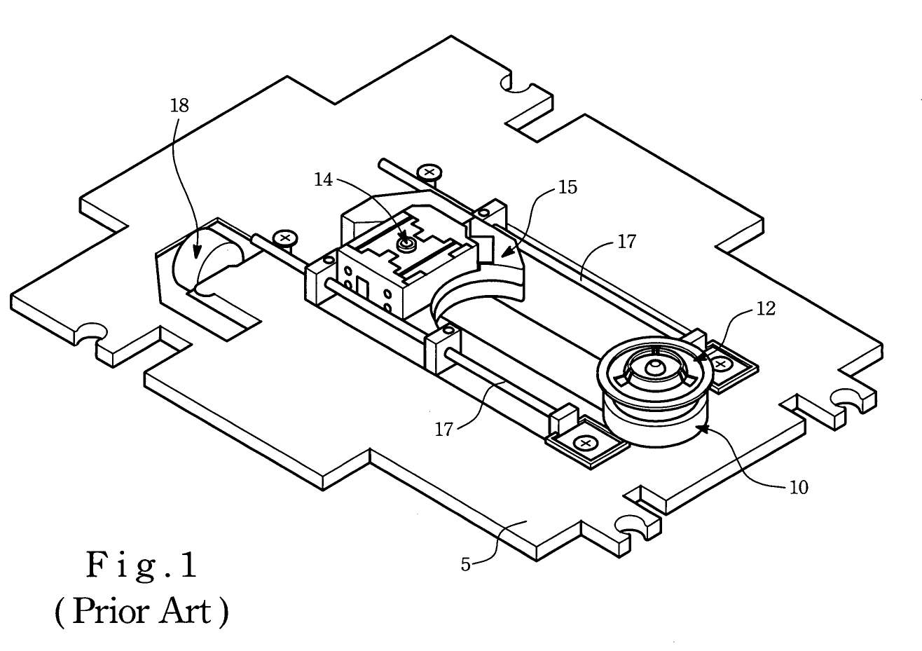

FIG. 2 is an exploded perspective view, illustrating relationship between a pick-up head, a heat sink of the first preferred embodiment of an optical recording. and/or reproducing instrument in accordance with to the present invention;

FIG. 3 is an exploded perspective view, illustrating relationship between the pick-up head, the heat sink of the second preferred embodiment of an optical recording and/or reproducing instrument in accordance with to the present invention; and

FIGS. 4A and 4B respectively show the side views of the pick-up head and the heat sink of the first preferred embodiment of an optical recording and/or reproducing instrument in accordance with to the present invention.

### DETAILED DESCRIPTIONS OF THE PREFERRED EMBODIMENTS

Before the present invention is described in greater detail with reference to the following preferred embodiments, it should be noted that same reference numerals have been used to denote similar elements throughout the specification.

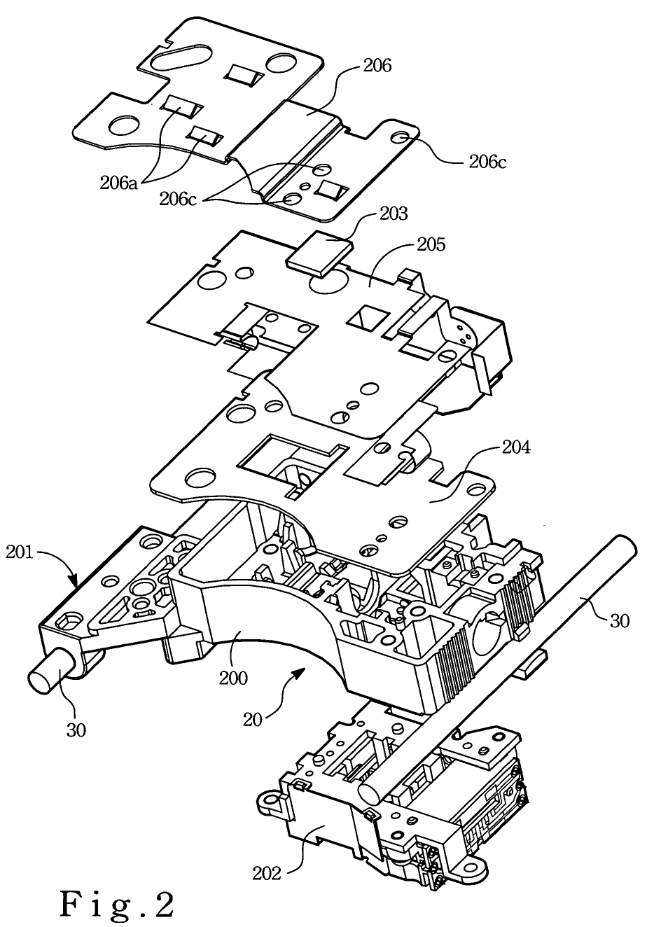

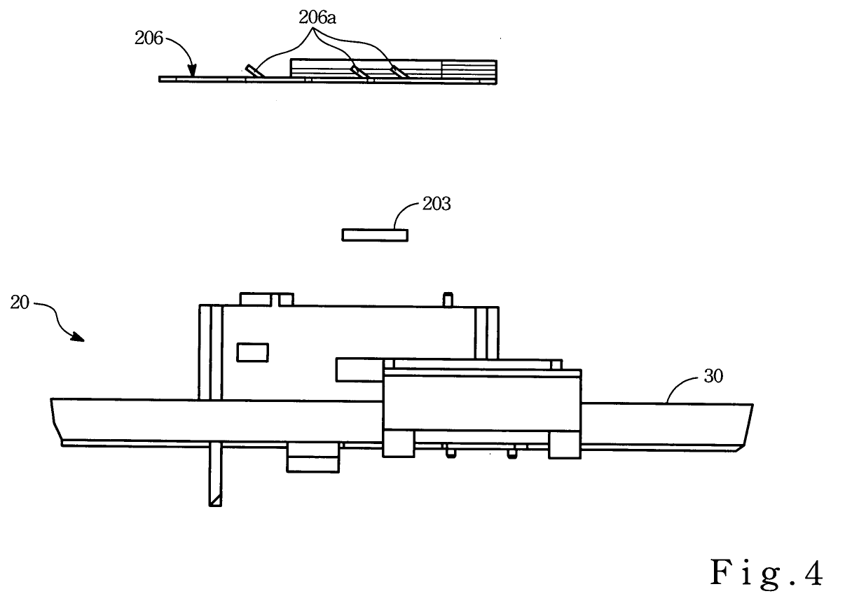

Referring to FIGS. 2, 4A and 4B, the first preferred embodiment of an optical recording and/or reproducing instrument (such as a DVD player) is shown to include a pick-up head 20 and a heat sink 206. The pick-up head 20 includes a carriage seat 200, an optical component (not shown), a laser diode (not shown), a voice coil motor 202, a control chip 203, a reinforced plate 204, and a flexible printed circuit (FPC) 205. The carriage seat 200 is loaded with the optical component, and has two opposite lateral sides 201 sleeved movably on two stationary rails 30 in the DVD casing (not shown).

The voice coil motor 202 is disposed below the carriage seat 200 for moving the latter horizontally and vertically relative to the rails 30 during the reading or recording operation of the optical disk. The laser diode is provided on the carriage seat 200 in such a manner to emit laser beams onto an optical disk (not shown) along a predetermined angle in order to read the data thereon or for recording data onto the optical disk. Since the structure of the pick-up head 20 is not the relevant feature of the present invention, a detailed description thereof is omitted herein for the sake of brevity.

The control chip 203 is soldered securely onto the flexible printed circuit 205 by SMT (surface mount technology). The reinforced plate 204 is disposed on the carriage seat 200 in order to provide support to the flexible printed circuit 205. The reinforced plate 204 can be made from plastic material or other materials so long as it can provide rigidity to the flexible printed circuit 205 such that the latter spreads over outer and lateral surfaces of the carriage seat 200.

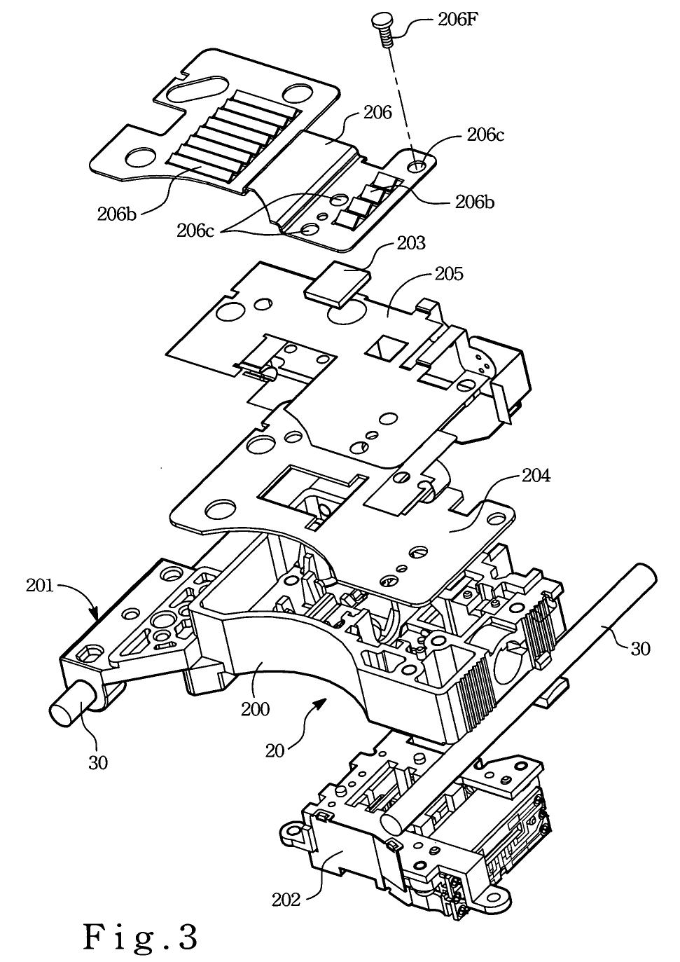

The heat sink 206 is disposed above the flexible printed circuit 205, covers the control chip 203, and has a plurality of mounting holes 206c. A plurality of fasteners 206F (only one is shown in FIG. 3) extend through the mounting holes 206c in the heat sink 206 for fastening the same on the carriage seat 200. The heat sink 206 has a plurality of protrusions (206a) projecting upwardly from an upper surface thereof. Each of the protrusions (206a) is in the form of a fin configuration. The heat sink 206 preferably has a plurality of inverted U-shaped slits, each of which is formed by punching operation and each of which is bent upwardly from the upper surface of the heat sink 206 in such a manner to define a respective one of the protrusions 206a. Alternately, the heat sink 206 may have a plurality of U-shaped slits, which are similarly treated in order to define a respective one of the protrusions 206a. Note that the protrusions 206a on the heat sink 206 are arranged downstream to the air flow direction of the suction fan (not shown) that is generally installed within the DVD casing in order to dissipate the heat generated due to operation of the DVD player. Since the air of the suction fan flows back toward the flexible printed circuit 205 after colliding the protrusions 206a of the heat sink 206, the temperatures of those electronic parts (not shown) that are mounted on the flexible printed circuit 205 can be lowered. The heat dissipating effect of the DVD player is accordingly increased. The bending of the protrusions 206a should not be limited to a specific orientation, but so long as the air can flow back toward the flexible printed circuit 205.

Referring to FIG. 3, the second preferred embodiment of a DVD player according to the present invention is shown to have a construction similar to the previous embodiment. Except that each of the protrusions 206b is in the corrugated form, and is integrally formed with an adjacent ones.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A pick-up head for an optical recording and/or reproducing instrument, comprising:
a carriage seat; and
a heat sink disposed on said carriage seat, and having a plurality of protrusions projecting upward therefrom.

2. The pick-up head for an optical recording and/or reproducing instrument according to claim 1, wherein each of said protrusions is in the form of a fin configuration.

3. The pick-up head for an optical recording and/or reproducing instrument according to claim 1, wherein each of said protrusions is in the corrugated form.

4. The pick-up head for an optical recording and/or reproducing instrument according to claim 1, wherein each of said protrusions is formed by punching operation.

5. The pick-up head for an optical recording and/or reproducing instrument according to claim 1, further comprising a control chip disposed on said carriage seat.

6. The pick-up head for an optical recording and/or reproducing instrument according to claim 5, wherein said control chip is disposed below said heat sink.

7. A pick-up head for an optical recording and/or reproducing instrument comprising:
a control chip;
a heat sink disposed above said control chip, and having a plurality of protrusions projecting upwardly therefrom.

8. The pick-up head for an optical recording and/or reproducing instrument according to claim 7, further comprising a plurality of fasteners, and a carriage seat disposed below said control chip, said heat sink being formed with a plurality of mounting holes, said fasteners extending through said mounting holes in said heat sink for fastening said carriage seat.

9. The pick-up head for an optical recording and/or reproducing instrument according to claim 7, wherein each of said protrusions of said heat sink is formed by punching operation.

10. The pick-up head for an optical recording and/or reproducing instrument according to claim 7, wherein said heat sink has an inverted U-shaped slit that is formed by punching operation and that is bent upwardly from an upper surface of said heat sink in such a manner to define a respective one of said protrusions.

11. The pick-up head for an optical recording and/or reproducing instrument according to claim 7, further comprising a guiding rail, said carriage seat being mounted movably on said guiding rail.

12. The pick-up head for an optical recording and/or reproducing instrument according to claim 7, further comprising a reinforced plate disposed on said carriage seat so as to provide support to said control chip.
